(19) United States
(12) Patent Application Publication
(10) Pub. No.: US 2016/0042472 A1
(43) Pub. Date: Feb. 11, 2016

(54) REAL TIME, DONOR-SPECIFIC, AUTOMATED, GRANT CONDITION COMPLIANT ACCOUNTING SOFTWARE FOR NONPROFIT ORGANIZATIONS

(71) Applicant: Faridoon S. Khosravi, Baltimore, MD (US)

(72) Inventor: Faridoon S. Khosravi, Baltimore, MD (US)

(21) Appl. No.: 14/919,146

(22) Filed: Oct. 21, 2015

Related U.S. Application Data
(63) Continuation-in-part of application No. 13/798,246, filed on Mar. 13, 2013.

(51) Int. Cl. G06Q 40/00; G06Q 10/06; G06Q 20/10

(52) U.S. Cl. CPC G06Q 40/12; G06Q 20/10; G06Q 10/06313

(57) ABSTRACT

An accounting system or application for nonprofit organizations may be configured to automatically move an appropriate amount of temporarily restricted funds to unrestricted funds as requirements for fund releases are met. The system or application may determine expenses that have occurred for each nonprofit organization project during a predetermined time period. The system or application may also automatically reduce temporarily restricted funds by the amount of the project expenses incurred during the predetermined time period or on demand, and automatically increase temporarily unrestricted funds by the amount of expenses incurred during the predetermined time period or on demand.

### CROSS REFERENCE TO RELATED APPLICATION

This application is a continuation-in-part of, and claims priority to, U.S. patent application Ser. No. 13/798,246 filed on Mar. 13, 2013. The subject matter of this earlier filed application is hereby incorporated by reference in its entirety.

### FIELD

The present invention generally pertains to accounting, and more specifically, to an accounting system or application for nonprofit organizations configured to automatically track donor pledges and payments, as well as nonprofit draw down and use of donor funds for qualifying expenses, for each donor pledge and in the aggregate for an entire organization.

### BACKGROUND

The 1993 publication of Financial Accounting Standards No. 116 (“FAS116”), requiring donor pledges to be recorded as receivables, has significantly complicated nonprofit accounting. Ever since going into effect, FAS116 has required donor pledges and payments and nonprofit qualifying expenses to be separately tracked. The latter might involve thousands of transactions on a weekly basis. Because conventional accounting software applications are generally designed for for-profit commercial and government contracting entities, rather than for donor-dependent nonprofits, they completely lack nonprofit accounting functionality.

Some existing software applications (e.g., Logos™, Interacct™, and Microsoft Dynamics Great Plains™) purport to be designed for nonprofit entities. However, these applications lack the capability to track the constant and fluid flow of receivables, their conversion to temporarily restricted funds, and release into unrestricted funds on an ongoing basis. As a result, nonprofits currently have to manually enter complex data into spreadsheets and conventional applications in an attempt to make them work for FAS116 purposes. These efforts are labor intensive and prone to human error, and they cannot be done with any frequency on a cost-effective basis. As a result, nonprofits do not know the precise moment when funds become unrestricted, but become aware only when they have completed the challenging process of manual entry and conforming of accounts. As such, effective tracking is not conventionally possible.

The ability of nonprofits to make use of their funding is thus handicapped in the current financial software environment. This has serious repercussions. At the very least, a nonprofit's mission is undermined because it must delay use of the donations for its good works. At worst, because pledges often carry deadlines for use of the funds, these accounting delays can require repayment of funds that have not been used in time. The nonprofit's reputation with donors for careful stewardship of donated resources can thus be damaged and its future viability endangered. Accordingly, an improved nonprofit accounting system or application for nonprofit organizations may be beneficial.

### SUMMARY

Certain embodiments of the present invention may be implemented to remedy the shortcomings in the art that conventional nonprofit accounting systems present. For example, some embodiments of the present invention automatically move an appropriate amount of temporarily restricted funds into unrestricted funds as requirements for fund releases are met. Some embodiments can perform these FAS116-required functions in real time, daily, monthly, quarterly, etc. Some embodiments can create separate data branches for each donor pledge (receivables), its payments on that pledge (temporarily restricted funds), and for nonprofit qualifying expenses attributed to that pledge (unrestricted funds). Temporarily restricted funds may be automatically moved to unrestricted funds as conditions of each pledge are met. Certain embodiments can track and monitor pledges from multiple donors to one project, and from one donor to multiple projects. This streamlined automation of fund movement is novel and not performed via conventional systems and practices. This is because large nonprofits often have thousands of qualifying events that, with current software, must be manually entered. This is a labor-intensive, tedious, error-prone, and impractical process. In other words, effective FAS116 compliance cannot be currently performed by these organizations using existing manual or computerized systems.

Some embodiments revolutionize nonprofit accounting by automating and streamlining the FAS116 tracking and release of donor pledges, donor payments, and nonprofit expenditures. By enabling nonprofits to accurately account for each of these categories of funds by donor pledge and by project, and in the aggregate and in real time, such embodiments provide an essential, novel, and heretofore nonexistent tool for regulatory compliance and for timely reporting and use of donor funds. FAS116 compliance and effective fund stewardship are essential for the long-term viability of nonprofits. Some embodiments provide a new, useful, and efficient mechanism for nonprofits to both comply with accounting requirements and utilize pledge funds.

Such embodiments are not merely a part of or an addition to an existing accounting practice and are not dictating how nonprofit accounting needs to be done. Those functions are the exclusive prerogative of authoritative bodies in the accounting profession, such as the Financial Accounting Standard Board (FASB). Rather, such embodiments configure data and implement code to create a mechanism to help nonprofit accounting to be compliant, and to avoid manual practices that are lengthy, overwhelming, costly, prone to errors, and utterly ineffective for organizations of any significant size. In other words, such embodiments have nothing to do with “why the coffee needs to be ground,” but rather provide a mechanism for “grinding the coffee” that is fast and easy, and which produces a “uniformly excellent grind.”

In one embodiment of the present invention, a computer program is embodied on a computer-readable storage medium. The computer program is configured to cause at least one processor to create separate branches for temporarily restricted funds and unrestricted funds in a project and determine when donor pledges are received for each project from at least one donor, and when a donor pledge is received, increase temporarily restricted funds for at least one project by an amount of the donor pledge and increase a billed receivables account by an amount of the pledge. The computer program is further configured to cause the at least one processor to track expenses incurred by at least one project during a predetermined time period or on demand, and at a designated time or time of demand, check whether conditions necessary for a release of funds from temporarily restricted funds to unrestricted funds have been met. Additionally, when the conditions for the release of the temporarily restricted funds have been met, the computer program is further configured to cause the at least one processor to decrease the temporarily restricted funds in the temporarily restricted funds branch for the at least one project by an amount of the expenses, and increase unrestricted funds in the unrestricted funds branch for the at least one project by the amount of the expenses.

In another embodiment of the present invention, a computer-implemented method includes creating, by a computing system, separate branches for temporarily restricted funds and unrestricted funds in a project for each donor and monitoring, by the computing system, at least one account to determine whether an expense has occurred for a nonprofit organization. The computer-implemented method also includes checking, by the computing system, whether the expense has occurred in a temporarily restricted project. When the expense has occurred in the temporarily restricted project and conditions for the release of temporarily restricted funds have been met, the computer implemented method further includes decreasing, by the computing system, the temporarily restricted funds for a project for at least one donor by an amount of the expense, and increasing, by the computing system, unrestricted funds for the at least one donor by the amount of the expense.

In yet another embodiment of the present invention, an apparatus includes physical memory including computer program instructions and at least one processor configured to execute the computer program instructions. The at least one processor is configured to create separate branches for temporarily restricted funds and unrestricted funds in a project for each donor and determine when donor pledges are received from at least one donor. When a donor pledge is received, the at least one processor is also configured to increase the temporarily restricted funds for the project by an amount of the donor pledge. The at least one processor is further configure to determine that an expense has occurred for the project in real time. When the expense has occurred and conditions for the release of temporarily restricted funds have been met, the at least one processor is also configured to automatically reduce the temporarily restricted funds for at least one donor by an amount of the expense, automatically increase unrestricted funds for the at least one donor by the amount of the expense, and determine when donor payments on pledges are received for each project.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a project diagram illustrating a project structure for maintaining temporarily restricted funds and their transfer upon release from restrictions, according to an embodiment of the present invention.

FIG. 2 is a project diagram illustrating the process for computing revenue for Donor 2 of FIG. 1, according to an embodiment of the present invention.

FIG. 3 is a flowchart illustrating a fund accounting process, according to an embodiment of the present invention.

FIG. 4 is a flowchart illustrating a fund accounting process, according to an embodiment of the present invention.

FIG. 5 is a flowchart illustrating a fund accounting process, according to an embodiment of the present invention.

FIG. 6 is a flowchart illustrating a fund accounting process, according to an embodiment of the present invention.

FIG. 7 illustrates a computing system for performing fund accounting, according to an embodiment of the present invention.

### DETAILED DESCRIPTION OF THE EMBODIMENTS

Some embodiments of the present invention use automated processes to move an appropriate amount of temporarily restricted funds into unrestricted funds as the requirements for the fund releases are met. This transfer can be achieved without manual entries in a conventional accounting software application or the use of auxiliary software and spreadsheets. Stated differently, the process of some embodiments is fully automated in a way that is not performed manually and/or implemented via computing systems before, unlike conventional systems. Some embodiments are able to provide financial data pertaining to temporarily restricted and unrestricted funds for each project, for each donor, or in the aggregate, that is readily available at the end of each accounting period, and/or on a fluid and ongoing basis. In essence, some embodiments may track (1) donor pledges for each project; (2) payments received on pledges for each project; (3) temporarily restricted funds for each project; and (4) unrestricted funds for each project. Some embodiments also automatically transfer temporarily restricted funds to unrestricted funds in real time as project conditions are met. Certain embodiments can automatically track and monitor multiple donor pledges to a single or multiple projects.

Since financial reports should be available on an ongoing basis, production of financial reports for each financial period was a challenge and required substantial manual effort for nonprofit organizations using conventional applications. To keep track of fund transfers from temporarily restricted to unrestricted funds, nonprofit organizations using conventional accounting software would require making manual entries and using auxiliary software such as Excel® spreadsheets to keep track of releases of funds from temporarily restricted to unrestricted funds. This process is tedious and less efficient than an automated process, and is prone to errors. Also, this process is simply not effective for FAS116 compliance for large nonprofit organizations. In other words, such organizations cannot effectively ensure FAS116 compliance with existing systems.

Some embodiments of the present invention may employ an automated process to transfer funds from temporarily restricted funds to unrestricted funds without manual entries and computations when the conditions for the transfer are met. Such embodiments may recognize temporarily restricted funds on a per-project basis. In some embodiments, the release of temporarily restricted funds to unrestricted funds in nonprofits takes place mostly when the nonprofit starts doing the work (and incurring expenses). Some embodiments recognize the spending associated with the project and move funds from temporarily restricted funds to unrestricted funds accordingly. Appropriate amounts of funds may be automatically transferred from temporarily restricted funds to unrestricted funds when the conditions for release are met, i.e., when project work is performed and expenses are incurred.

In conventional accounting software, manual computation and manual entry is required to move the correct portion of the temporarily restricted funds to unrestricted funds when the requisite criteria are met, and this simply cannot reasonably be done for large nonprofit organizations with accuracy and optional frequency. Certain embodiments automatically make the fund transfers without human intervention, which has the benefit of being faster and more efficient than the long and tedious process of manual calculation and entry, and has the further benefit of avoiding human error. Economically, such embodiments may reduce the number of hours required and the complexity of the work performed for accounting in nonprofit organizations and speed up the monthly closing process. Furthermore, such embodiments ensure timely and efficient FAS116 compliance and use of available funds for large organizations, which is not currently possible with conventional systems in an effective, automated fashion.

To record and maintain temporarily restricted and unrestricted funds, it is generally beneficial to create various accounts to track funds for each project. In some embodiments, these accounts may be those listed below in Table 1.

TABLE 1
NONPROFIT PROJECT FUND ACCOUNTS
Account Description:

Temporarily Restricted Revenue
Contra Revenue
Unrestricted Revenue
Cash in Bank
Billed Receivables
Fund Balance

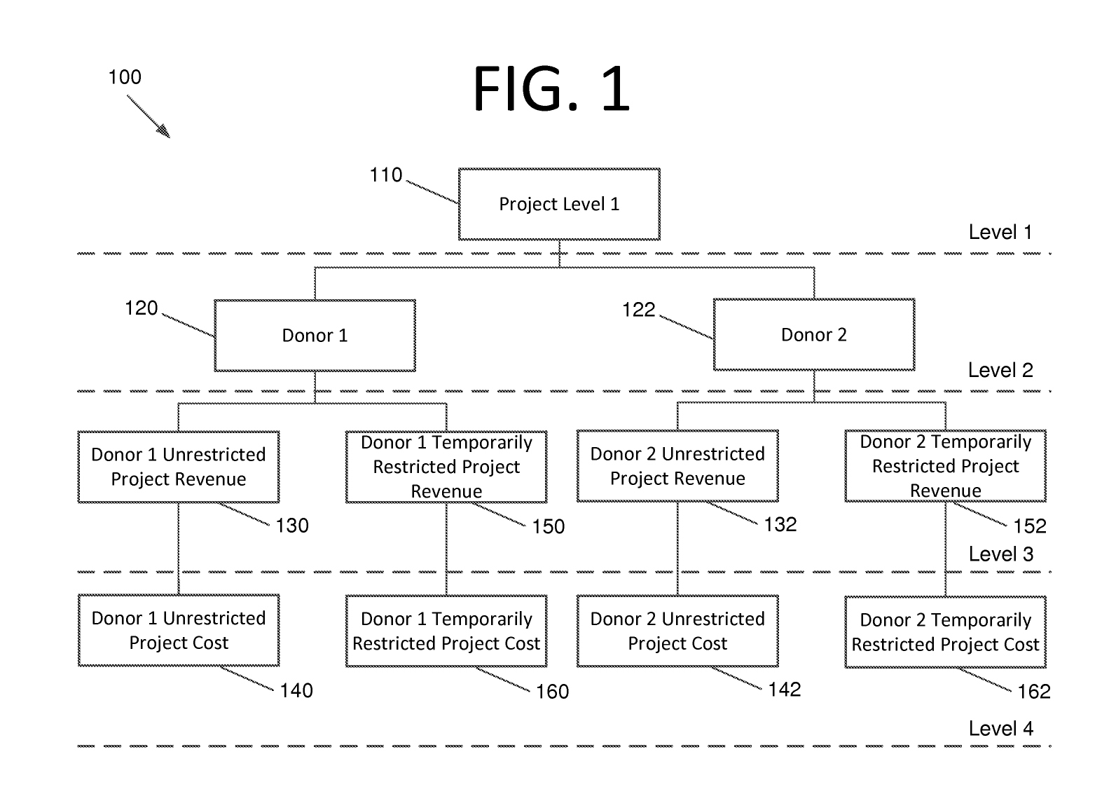

FIG. 1 is a project diagram 100 illustrating a project structure for maintaining temporarily restricted funds and their transfer upon release from restrictions, according to an embodiment of the present invention. In some embodiments, the project structure is a logical data structure that captures data pertaining to revenue and expenses. The structure of the project may be important to proper functionality of some embodiments in order to facilitate moving data through proper channels during various processes. The project structure also facilitates computation of both temporarily restricted and unrestricted revenue. Unique branches are created for each project, and these branches further split into two separate branches for temporarily restricted and unrestricted funds.

The top level (level 1) of the project includes Project Level 1 110, which serves as a holder for all project donors contributing to that project (i.e., activity). Level 2 includes all of the individual project donors. Here, Donor 1 120 holds temporarily restricted and unrestricted branches for Donor 1. Similarly, Donor 2 122 holds temporarily restricted and unrestricted branches for Donor 2.

Level 3 includes temporarily restricted and unrestricted project revenue for each donor, namely, Donor 1 Unrestricted Project Revenue 130, Donor 2 Unrestricted Project Revenue 132, Donor 1 Temporarily Restricted Project Revenue 150, and Donor 2 Temporarily Restricted Project Revenue 152. Level 4 includes project costs, namely, Donor 1 Unrestricted Project Cost 140, Donor 2 Unrestricted Project Cost 142, Donor 1 Temporarily Restricted Project Cost 160, and Donor 2 Temporarily Restricted Project Cost 162. In FIG. 1, the restricted and unrestricted branches divide out at level 3, but in some embodiments, they may branch out at any level. However, the restricted and unrestricted revenue branches should be separate in any case. Expense reclassifications may be setup to move costs from the restricted project branches to the unrestricted project branches.

In some embodiments, the entire amount of the pledge is entered as temporarily restricted revenue, even if the pledge is to be paid in multiple payments, whether in the same fiscal year or future years, per FAS116. Invoices may be created for all payments with the appropriate due dates according to the pledge. During the month, all expenses (i.e., costs) may be charged to the temporarily restricted branch of the project at the expense level of the project.

An expense reclassification may be run and the entry may be posted to transfer all charges from the temporarily restricted project to the unrestricted project. The running of this computation may be automated, and it may be set to occur on a recurring basis, or on demand. Alternatively, a cost transfer process may be established and used to move expenses from the temporarily restricted funds for that project to the unrestricted funds for that project.

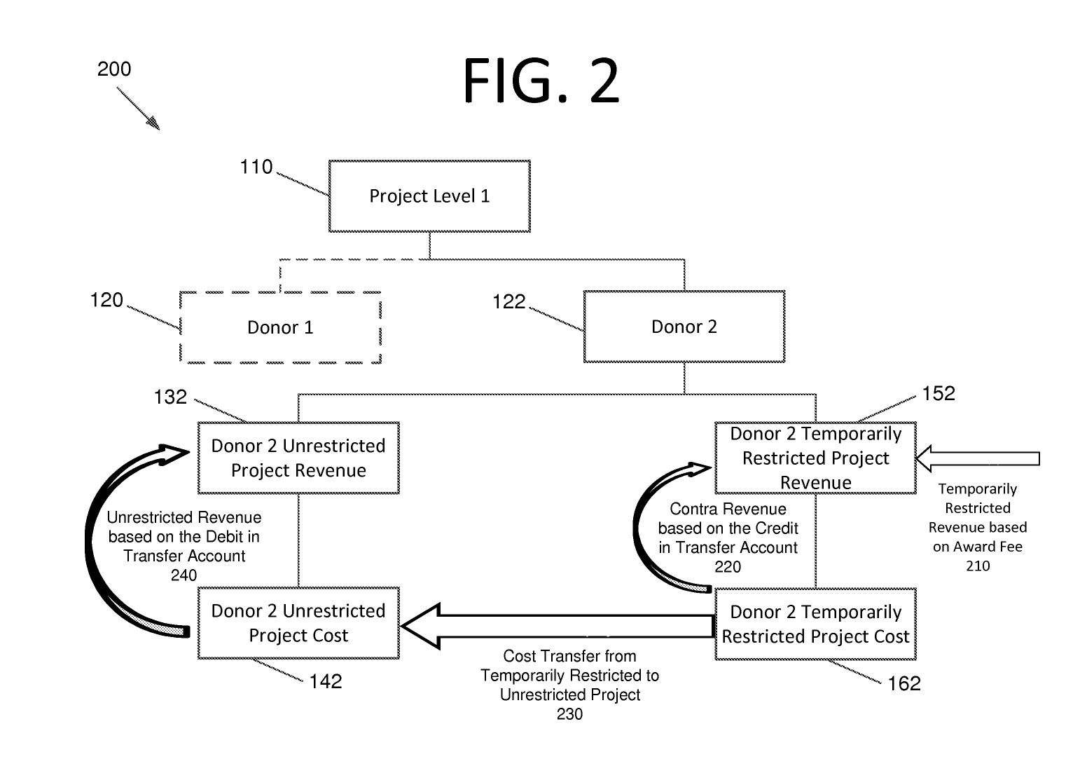

FIG. 2 is a project diagram 200 illustrating the process for computing revenue for Donor 2 of FIG. 1, according to an embodiment of the present invention. The system creates temporarily restricted revenue 210 based on a pledge amount entered into Donor 2 Temporarily Restricted Revenue 210. The system then creates negative revenue in the contra revenue account 220 for Donor 2 Temporarily Restricted Revenue 210 based on a negative balance in the cost transfer account. The expense reclassification puts a credit in the temporarily restricted project. When revenue is computed in some embodiments, the system creates a revenue reduction entry (i.e., a debit to the contra revenue account). The contra (negative) revenue, combined with the original temporarily restricted revenue, reduces the overall temporarily restricted revenue. On the other hand, the same expense reclassification puts a debit cost in the unrestricted branch for Donor 2, which creates an increase in the unrestricted revenue in the unrestricted branch of the project for Donor 2 of the same amount. As a result, the temporarily restricted revenue is reduced by the amount of the incurred cost and the unrestricted revenue is increased by the same amount. Computation and posting of revenue can be set to occur automatically.

A cost transfer then occurs at 230 from Donor 2 Temporarily Restricted Project Cost 162 to Donor 2 Unrestricted Project Cost 142. Unrestricted revenue is then transferred at 240 from Donor 2 Unrestricted Project Cost 142 to Donor 2 Unrestricted Project Revenue 132. The net result of this process is a reduction in temporarily restricted revenue (i.e., temporarily restricted revenue minus contra revenue) and an increase in unrestricted revenue in the unrestricted branch of the project.

An alternative setup for this process in some embodiments is to create a dummy project to record all expenses and move those expenses either through expense reclassification, project transfers, or regular journal entries as discussed before to allocate the expenses to the unrestricted project based on other criteria, such as the percentage of the donor's share in project expenses. Once this is done, the steps in the process may be similar to 220, 230, and 240 in FIG. 2.

It should be noted that the specific structure of the project tree in some embodiments is dependent on the specific organization's preferences. Some embodiments facilitate the transfer of funds from temporarily restricted revenue to unrestricted revenue by account types. These account types may refer to the restricted revenue, cost transfer, etc., and automated system processes such as expense reclassification processing, revenue computation, and billing may be used to eliminate manual entries for those transfers. In other words, some embodiments utilize specific codes to label and flag each transaction that triggers the release of funds from restricted to unrestricted funds. An amount equal to those qualified transactions is then transferred from temporarily restricted funds to unrestricted funds at predetermined times or on demand. The transactions may be sorted and stored separately, and certain processes in the software may reclassify the transactions as they meet the qualifications to trigger the release of funds from temporary restricted funds to unrestricted funds.

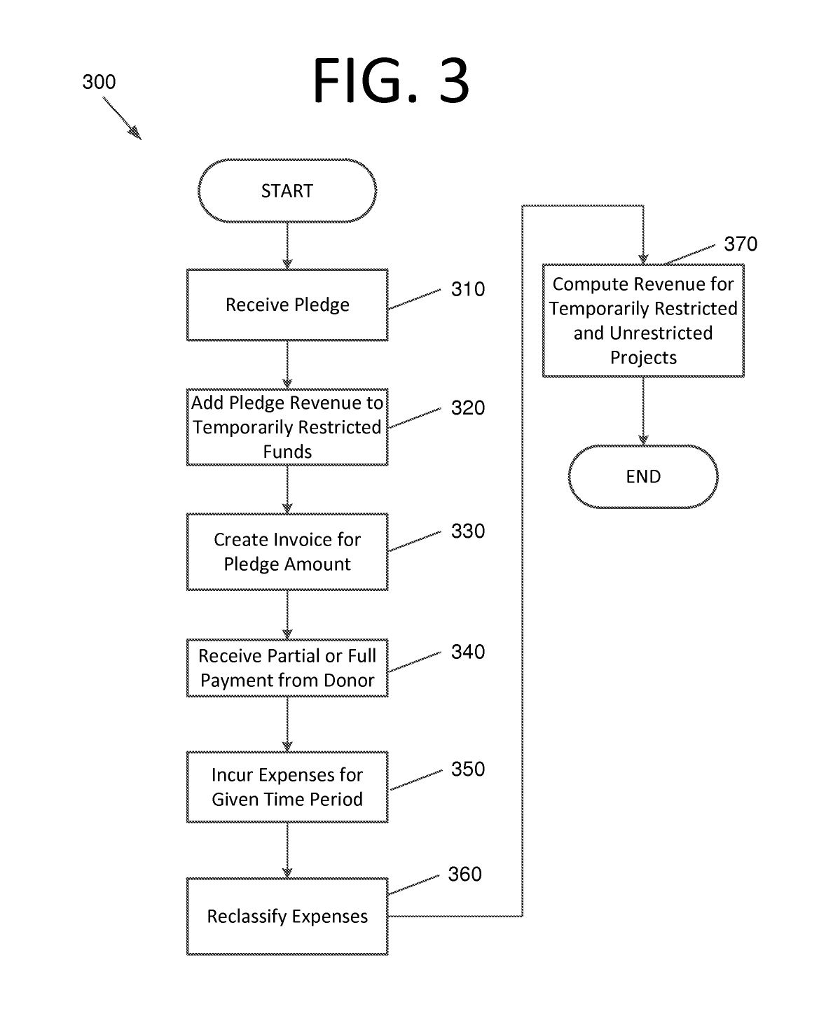

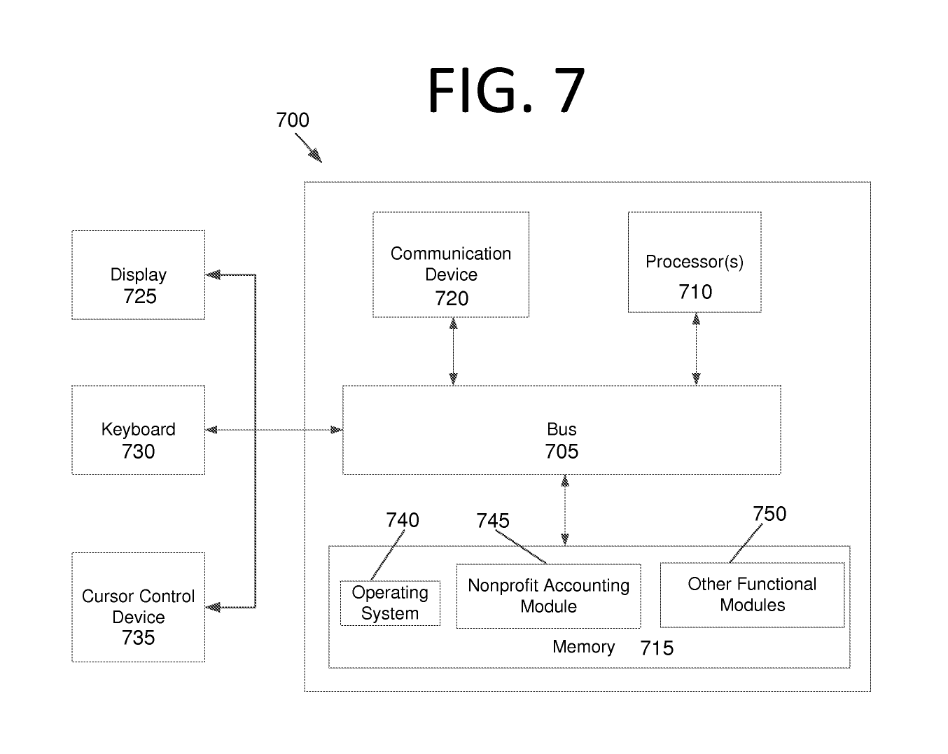

FIG. 3 is a flowchart 300 illustrating a fund accounting process, according to an embodiment of the present invention. In some embodiments, the process of FIG. 3 may be performed, for example, by computing system 700 of FIG. 7. The process begins with receiving a pledge from a donor at 310. The pledge revenue is added to temporarily restricted funds at 320 and an invoice for the pledge amount is created at 330.

At 340, a partial payment for the pledge is received from the donor. However, in some embodiments, the entire pledge amount may be recorded as received. Expenses for a given time period are incurred at 350. This time period, for example, may be monthly, quarterly, a custom-defined time period, or on demand, as would be readily appreciated by a person of ordinary skill in the art. Expense reclassification operations are performed at 360. Revenues for unrestricted and temporarily restricted accounts are then computed at 370 and the process ends.

An example of a fund accounting process according to an embodiment of the present invention is provided below. This example is similar to the process of FIG. 3. Table 2 provides accounts for this example.

TABLE 2
EXAMPLE ACCOUNTS

| Acct. Number: | Acct. Description: |
|---|---|
| 310-10 | Temporarily Restricted |
| | Revenue |
| 310-00 | Contra Revenue |
| 310-01 | Unrestricted Revenue |
| 100-01 | Cash in Bank |
| 110-00 | Billed Receivables |
| 120-00 | Fund Balance |
| 990-10 | Expense Reclass |
| 990-20 | Expense Reclass |

In this example, a pledge of $2,000,000 is received from a donor, and a temporarily restricted revenue of $2,000,000 is entered. Next, the system computes revenue and creates revenue of $2,000,000 in a temporarily restricted project.

| Account | Project | Dr. Amount | Cr. Amount |
|---|---|---|---|
| 120-00 | DONOR2.TEPMRESTR.00 | $2,000,000 | |
| 310-10 | DONOR2.TEPMRESTR.00 | | $2,000,000 |

An invoice is created for the amount of the pledge in the same project.

| Account | Project | Dr. Amount | Cr. Amount |
|---|---|---|---|
| 110-00 | DONOR2.TEPMRESTR.00 | $2,000,000 | |
| 120-00 | DONOR2.TEPMRESTR.00 | | $2,000,000 |

At some point after the pledge, a payment of $1,000,000 is received from the donor. As a result, the system makes a $1,000,000 debit to Cash in Bank 100-01 and adds a $1,000,000 credit to Billed Receivables 110-00. At the end of the month, $550,000 in expenses have been incurred in the temporarily restricted branch of the donor project. The following expense reclassifications are performed.

| | | Dr. | Cr. |
|---|---|---|---|
| Account | Project | Amount | Amount |
| 990-20 | DONOR2.UNRESTR.00 | $550,000 | |
| 990-10 | DONOR2.TEPMRESTR.00 | | $550,000 |

The revenue is then computed. The credit amount in account 990-10 creates a contra revenue amount, reducing the overall revenue for the temporarily restricted project by the amount of expenses incurred.

| | | | |
|---|---|---|---|
| 310-00 | DONOR2.TEPMRESTR.00 | $550,000 | |
| 120-00 | DONOR2.TEPMRESTR.00 | | $550,000 |

The debit amount in 990-20 created a positive revenue amount in the unrestricted project by the amount of expenses incurred.

| | | | |
|---|---|---|---|
| 120-00 | DONOR2.UNRESTR.00 | $550,000 | |
| 310-01 | DONOR2.UNRESTR.00 | | $550,000 |

The account balance may be analyzed after processing all transactions in the time period as follows.

| Account | Activity | Amount |
|---|---|---|
| 110-00 | Receivable balance of $1,000,000 | $1,000,000 |
| 100-01 | Increase in bank by $1,000,000 for payment | $1,000,000 |
| | received | |
| 120-00 | Nets out to zero for overall project | $0 |
| 310-01 | Shows a balance of $550,000 in unrestricted | ($550,000) |
| | revenue as a result of expenses incurred | |
| 310-00 | Shows a balance of $550,000 in negative revenue | $550,000 |
| | for the temporarily restricted project | |
| 310-10 | Shows a balance of $2,000,000 in positive | $2,000,000 |
| | revenue for the temporarily restricted project | |
| *** | The net revenue for the temporarily restricted | $1,450,000 |
| | project will be $1,450,000 | |

During the revenue computation, the zero ceiling level on all other direct limits the computation of the revenue to only be based on the account balances for 990-10 and 990-20. At the end of the fiscal year when the books are closed, assuming no other donations/expenses, the net revenue for temporarily restricted revenue will be $1,450,000 and the net revenue for unrestricted revenue will be $550,000.

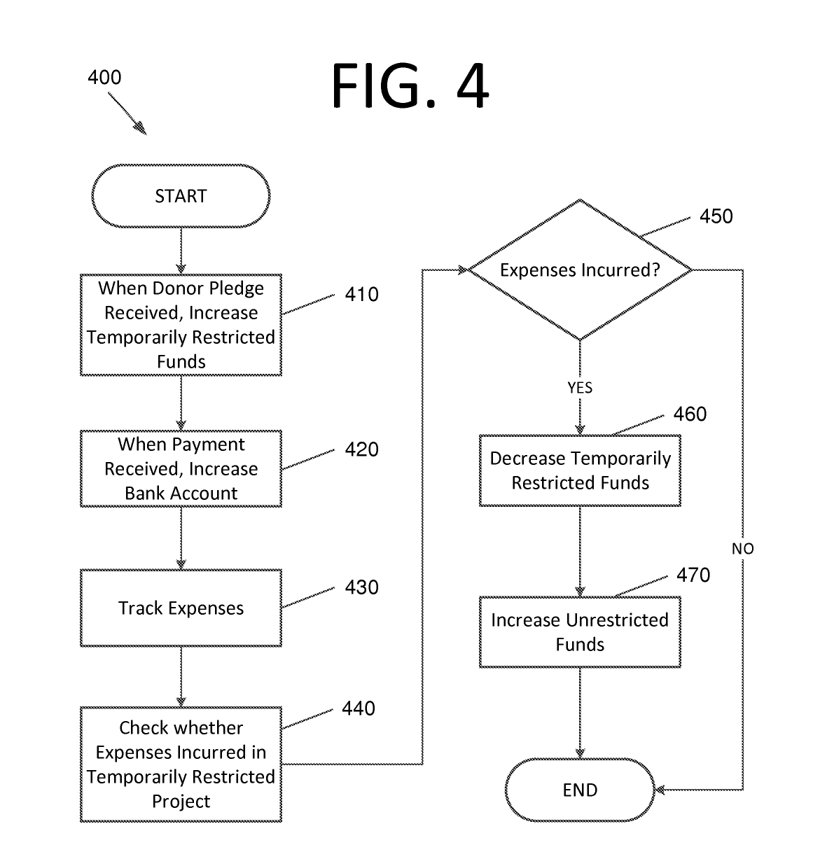

FIG. 4 is a flowchart 400 illustrating a fund accounting process, according to an embodiment of the present invention. In some embodiments, the process of FIG. 4 may be performed, for example, by computing system 700 of FIG. 7. The process begins with determining when donor pledges are received from one or more donors, and when a donor pledge is received, increasing temporarily restricted funds for the appropriate project or projects by an amount of each donor pledge at 410. The process also includes determining when a payment on a donor pledge is received, and when the payment is received, increasing the bank account by an amount of the payment at 420. The process further includes tracking expenses incurred for each project during a predetermined time period at 430.

After the predetermined time period elapses, the process proceeds to checking whether expenses have been incurred in the temporarily restricted funds for the project at 440. When the expenses have been incurred at 450, the temporarily restricted funds are decreased by an amount of the expenses at 460, and unrestricted funds are increased by the amount of the expenses at 470.

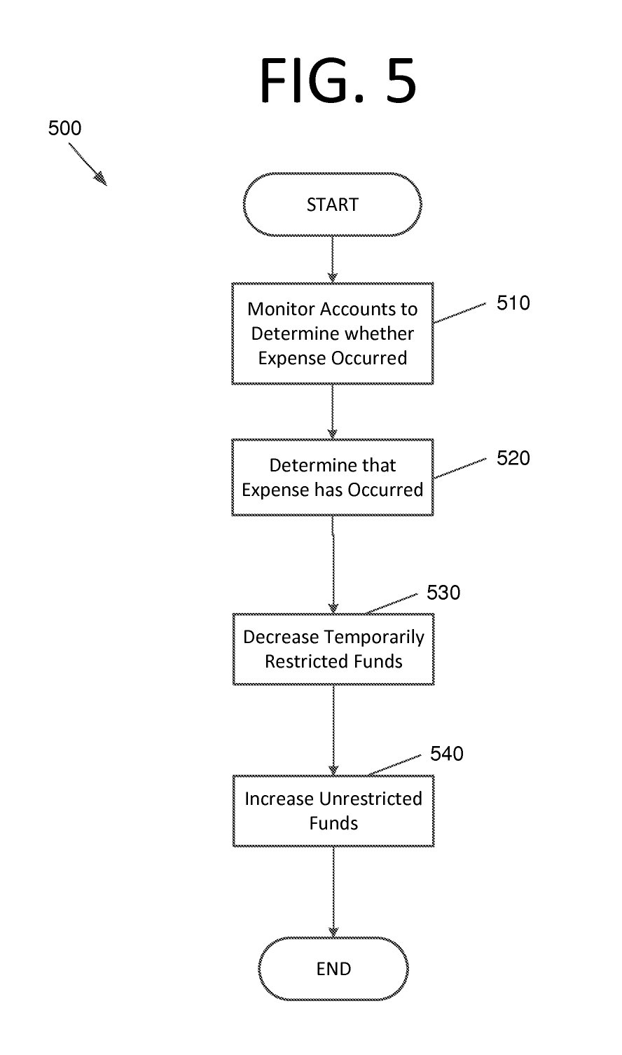

FIG. 5 is a flowchart 500 illustrating a fund accounting process, according to an embodiment of the present invention. In some embodiments, the process of FIG. 5 may be performed, for example, by computing system 700 of FIG. 7. The process begins with monitoring one or more accounts to determine whether an expense has occurred for the specific project at 510. The process also includes determining based on the monitoring, that an expense has occurred for the specific project at 520. The temporarily restricted funds for that project are then decreased by an amount of the expense at 530, and the unrestricted funds are increased by the amount of the expense at 540.

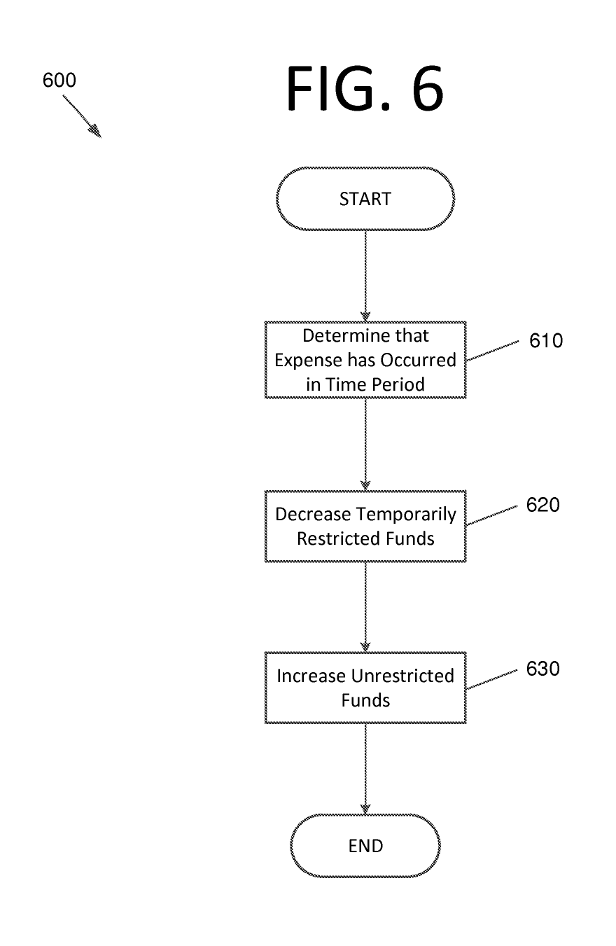

FIG. 6 is a flowchart 600 illustrating a fund accounting process, according to an embodiment of the present invention. In some embodiments, the process of FIG. 6 may be performed, for example, by computing system 700 of FIG. 7. The process begins with determining expenses that have occurred for a specific project during a predetermined time period at 610. The temporarily restricted funds are then automatically reduced by an amount of the expenses incurred during the predetermined time period at 620, and unrestricted funds are automatically increased by the amount of expenses incurred during the predetermined time period at 630.

FIG. 7 illustrates a computing system for performing fund accounting, according to an embodiment of the present invention. System 700 includes a bus 705 or other communication mechanism for communicating information, and processor(s) 710 coupled to bus 705 for processing information. Processor(s) 710 may be any type of general or specific purpose processor, including a central processing unit (“CPU”) or application specific integrated circuit (“ASIC”). Processor(s) 710 may also have multiple processing cores, and at least some of the cores may be configured for specific functions. System 700 further includes a memory 715 for storing information and instructions to be executed by processor(s) 710. Memory 715 can be comprised of any combination of random access memory (“RAM”), read only memory (“ROM”), flash memory, cache, static storage such as a magnetic or optical disk, or any other types of non-transitory computer-readable media or combinations thereof. Additionally, system 700 includes a communication device 720, such as a transceiver, to wirelessly provide access to a communications network.

Non-transitory computer-readable media may be any available media that can be accessed by processor(s) 710 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 710 are further coupled via bus 705 to a display 725, such as a Liquid Crystal Display (“LCD”), for displaying information to a user. A keyboard 730 and a cursor control device 735, such as a computer mouse, are further coupled to bus 705 to enable a user to interface with system 700. However, in certain embodiments such as those for mobile computing implementations, a physical keyboard and mouse may not be present, and the user may interact with the device solely through display 725 and/or a touchpad (not shown). Any type and combination of input devices may be used as a matter of design choice.

In one embodiment, memory 715 stores software modules that provide functionality when executed by processor(s) 710. The modules include an operating system 740 for system 700. The modules further include a nonprofit accounting module 745 that is configured to perform FAS116-based accounting for nonprofit organizations. System 700 may include one or more additional functional modules 750 that include additional functionality.

One skilled in the art will appreciate that a “system” could be embodied as a personal computer, a server, a console, a personal digital assistant (“PDA”), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The method steps performed in FIGS. 3-6 may be performed by a computer program, encoding instructions for the nonlinear adaptive processor to perform at least the methods described in FIGS. 3-6, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the methods described in FIGS. 3-6, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer program embodied on a computer-readable storage medium, the computer program configured to cause at least one processor to:
create separate branches for temporarily restricted funds and unrestricted funds in a project;
determine when donor pledges are received for each project from at least one donor, and when a donor pledge is received, increase temporarily restricted funds for at least one project by an amount of the donor pledge and increase a billed receivables account by an amount of the donor pledge;
track expenses incurred by the at least one project during a predetermined time period or on demand;
at a designated time or time of demand, check whether conditions necessary for a release of funds from temporarily restricted funds to unrestricted funds have been met; and
when the conditions for the release of the temporarily restricted funds have been met, decrease the temporarily restricted funds in the temporarily restricted funds branch for the at least one project by an amount of the expenses, and increase unrestricted funds in the unrestricted funds branch for the at least one project by the amount of the expenses.

2. The computer program of claim 1, wherein the conditions necessary for the release of the temporarily restricted funds comprise when work has been performed and expenses are incurred.

3. The computer program of claim 1, wherein the program is further configured to cause the at least one processor to track project cost and project revenue separately for each of the branches.

4. The computer program of claim 1, wherein when the conditions necessary for the release of the funds are met, the program is further configured to cause the at least one processor to:
subtract contra revenue in an amount of the incurred expenses from temporarily restricted project revenue;
transfer cost in the amount of the expenses from temporarily restricted project cost to unrestricted project cost; and
compute unrestricted revenue in an amount of qualified expenses in the unrestricted project.

5. The computer program of claim 1, wherein the designated time is for any specified time period or on demand.

6. The computer program of claim 1, wherein the transfer of funds from temporarily restricted revenue to unrestricted revenue is performed using account types for respective accounts that label and flag each transaction, triggering release of the funds from temporarily restricted revenue to unrestricted revenue.

7. The computer program of claim 6, wherein revenue or restricted revenue cost transfer are utilized.

8. The computer program of claim 6, wherein transactions are sorted and stored separately, and the transactions are reclassified as they meet qualifications to trigger the release of funds from temporarily restricted funds to unrestricted funds.

9. A computer-implemented method, comprising:
creating, by a computing system, separate branches for temporarily restricted funds and unrestricted funds in a project for each donor;
monitoring, by the computing system, at least one account to determine whether an expense has occurred for a nonprofit organization;
checking, by the computing system, whether the expense has been incurred in a temporarily restricted project; and
when the expenses have been incurred in the temporarily restricted project and conditions for release of temporarily restricted funds have been met, decreasing, by the computing system, the temporarily restricted funds for a project for at least one donor by an amount of the expense, and increasing, by the computing system, unrestricted funds for the at least one donor by the amount of the expense.

10. The computer-implemented method of claim 9, further comprising:
when a donor payment is received, increasing, by the computing system a bank account for the nonprofit organization by an amount of the donor payment.

11. The computer-implemented method of claim 9, wherein the project cost and project revenue are tracked separately for each of the branches.

12. The computer-implemented method of claim 9, wherein conditions necessary for the release of the temporarily restricted funds comprise when work has been performed and expenses are incurred.

13. The computer-implemented method of claim 9, wherein when the conditions necessary for the release of the funds are met, the method further comprises:
subtracting, by the computing system, contra revenue in an amount of the incurred expenses from temporarily restricted project revenue;
transferring, by the computing system, cost in the amount of the expenses from temporarily restricted project cost to unrestricted project cost; and
creating, by the computing system, unrestricted revenue in the amount of the expenses from unrestricted project cost to unrestricted project revenue.

14. An apparatus, comprising:
physical memory comprising computer program instructions; and
at least one processor configured to execute the computer program instructions, the at least one processor configured to:
create separate branches for temporarily restricted funds and unrestricted funds in a project for each donor,
determine when donor pledges are received from at least one donor,
when a donor pledge is received, increase the temporarily restricted funds for the project by an amount of the donor pledge,
determine that an expense has occurred for the project in real time, and
when the expense has occurred and conditions for the release of temporarily restricted funds have been met, automatically reduce the temporarily restricted funds for at least one donor by an amount of the expense, automatically increase unrestricted funds for the at least one donor by the amount of the expense, and determine when donor payments on pledges are received for each project.

15. The apparatus of claim 14, wherein the conditions necessary for the release of the temporarily restricted funds comprise when work has been performed and expenses are incurred.

16. The apparatus of claim 14, wherein when the conditions necessary for the release of the funds are met, the at least one processor is further configured to:
subtract contra revenue in an amount of the incurred expenses from temporarily restricted project revenue;
transfer cost in the amount of the expenses from temporarily restricted project cost to unrestricted project cost; and
transfer unrestricted revenue in the amount of the expenses from unrestricted project cost to unrestricted project revenue.

17. The apparatus of claim 14, wherein the at least one processor is further configured to determine when a payment on a donor pledge is received, and when the payment is received, increase a bank account by an amount of the payment.

18. The apparatus of claim 14, wherein the transfer of funds from temporarily restricted revenue to unrestricted revenue is performed using account types for respective accounts that label and flag each transaction, triggering release of the funds from temporarily restricted revenue to unrestricted revenue.

19. The apparatus of claim 18, wherein revenue or restricted revenue cost transfer are used.

20. The apparatus of claim 18, wherein the at least one processor is further configured to:
sort and store transactions separately; and
reclassify the transactions as they meet qualifications to trigger the release of funds from temporarily restricted funds to unrestricted funds.
